(19) United States
(12) Patent Application Publication
(10) Pub. No.: US 2024/0102541 A1
(43) Pub. Date: Mar. 28, 2024

(54) SPINDLE ASSEMBLY FOR A SPINDLE DEVICE

(71) Applicant: Edscha Engineering GmbH, Remscheid (DE)

(72) Inventors: Joerg DOERNEN, Remscheid (DE); Peter MROWKA, Remscheid (DE); Christian BARTSCHIES, Remscheid (DE)

(21) Appl. No.: 18/270,188

(22) PCT Filed: Dec. 1, 2021
(86) PCT No.: PCT/DE2021/100956

§ 371 Date: Jun. 28, 2023

(30) Foreign Application Priority Data
Jan. 4, 2021 (DE) 20 2021 100 014.7

(51) Int. Cl. F16H 25/24

(52) U.S. Cl. CPC F16H 25/24; F16H 2025/2481; F16H 2025/249

(57) ABSTRACT

A spindle assembly is for a spindle device, and comprises a spindle nut, which can be brought into thread engagement with a spindle rod, and a tube extending axially along a longitudinal axis, wherein the tube at least partly encircles the spindle nut radially. A spindle assembly for a spindle device is provided. The spindle nut is axially secured to the tube by a welding process.

The present disclosure relates to a spindle assembly for a spindle device.

### BACKGROUND

Spindle devices which comprise a spindle rod and a spindle nut in threaded engagement with the spindle rod are known from practice. Furthermore, spindle devices known from practice often comprise a guide tube made of metal which serves for radial guidance of the spindle rod and/or the spindle nut. Furthermore, it is known to connect the spindle nut to the guide tube in a stationary manner or to secure it axially, wherein the guide tube itself is, in turn, fixedly connected to a housing part of a drive device. The spindle nut then forms a spindle assembly with the guide tube, which spindle assembly can be mounted as an integrated component into a spindle device. Advantageously, the spindle device can be used as a linear actuator for a drive system, which by a linear movement of two housing parts movable relative to one another, can drive for example a pivoting movement of a vehicle door relative to a vehicle body. In this case, the spindle nut is connected via the guide tube to a first housing part, and the spindle rod is connected to a second housing part, wherein the first housing part is connected in an articulated manner to one of the vehicle door and the vehicle body and the second housing part is connected to the other one of the vehicle door and vehicle body.

### SUMMARY

The object of the present disclosure is to provide a spindle assembly for a spindle device which allows a space-saving and flexible design of the spindle device and is moreover robust and inexpensive to produce.

According to the present disclosure, this object is achieved by a spindle assembly for a spindle device.

According to one aspect of the present disclosure, a spindle assembly for a spindle device is provided, comprising a spindle nut with an internal thread, wherein the spindle nut can be brought into threaded engagement with a spindle rod. The spindle assembly further comprises a tube extending axially along a longitudinal axis, wherein the tube at least in a section surrounds the spindle nut radially. The spindle assembly according to the present disclosure is characterized in that the spindle nut is axially secured to the tube by welding. This advantageously creates a spindle assembly for a spindle device which allows, in particular, a more flexible arrangement of the spindle nut within the spindle assembly. Moreover, due to the more flexible selection of the axial position of the spindle nut before welding, it is also possible to advantageously adapt the overall length of the spindle assembly or of the spindle device. Further advantageously, it is not necessary to provide a particular geometry for the spindle nut or of the tube in order to achieve an axial securing. Corresponding complex mechanical machining processes are omitted. For example, it is not necessary to provide guide grooves on the guide tube or the spindle nut in order to secure the spindle nut axially and also against a rotational movement in the tube by pressing or the like. Finally, the use of adhesives is not necessary and the axial securing can advantageously take place much more quickly, since no time-consuming drying of adhesive or the like is necessary during welding.

Particularly preferably, the spindle nut is axially secured to the tube by laser welding. Advantageously, a particularly fast fastening of the spindle nut to the tube can be carried out by means of laser welding. Furthermore, welding can be carried out particularly precisely and possibly also in an automated manner.

In an advantageous embodiment of the spindle assembly, it is provided for the spindle nut to be made of a plastic. Advantageously, the total weight of the spindle assembly or of the spindle device can thereby be reduced, wherein the production of the spindle nut is also particularly inexpensive. Further advantageously, the spindle nut is designed to be sufficiently robust so that a maintenance-friendly and reliable operation of the spindle device comprising the spindle nut group is made possible. Moreover, with known plastic production methods it is possible to produce the spindle nut in high quantities with great and reproducible dimensional accuracy.

Particularly preferably, it is provided for the spindle nut to consist at least at an outer circumference of a laser-nontransparent plastic. This advantageously creates the possibility of locally melting or heating the spindle nut by a laser, so that welding of the spindle nut to an inner side of the tube is possible.

It is expediently provided for the tube to consist at least in sections of a plastic. Particularly preferably, the tube consists entirely of plastic. This advantageously reduces the total weight of the spindle assembly and also the production costs. The tube is expediently made of a laser-transparent plastic. Advantageously, a laser beam can thus be guided through a hollow cylindrical wall of the tube without the tube being damaged or locally melted by heating.

In an advantageous development, the spindle nut is arranged at a first open end of the tube. Particularly preferably, the spindle nut protrudes from the first end of the tube. The spindle nut is expediently arranged concentrically about the longitudinal axis of the tube. Advantageously, the entire length of the spindle assembly can thus be varied by positioning the spindle nut at the first open end of the tube. Expediently, the spindle nut and the tube radially surrounding the spindle nut overlap in an axial overlap region. Preferably, the spindle nut and the tube touch in the axial overlap region.

Particularly advantageously, there is at least a frictional connection between the spindle nut and the tube in the overlap region between the spindle nut and the tube. Advantageously, the frictional connection allows for the spindle nut to be inserted into the first open end of the tube and to be positioned accordingly before being welded to the tube. The frictional connection between the spindle nut and the tube prevents the spindle nut from moving or tilting in the tube at least during assembly and the subsequent securing via welding.

Particularly preferably, the spindle nut and the tube are welded to one another in an inner region of the axial overlap region. In an advantageous development, it is provided for the spindle nut and the tube to be connected to one another in the overlap region via at least one first welding point. In an expedient embodiment, the spindle nut and the tube are connected to one another in the overlap region via a second welding point spaced apart from the first welding point.

Preferably, the first welding point is provided in a central portion of the overlap region. Advantageously, there is thus no welding bead that would be visible from outside or possibly interfere with or negatively influence the other components outside the spindle assembly. Moreover, components that are evaporated during the welding process are furthermore advantageously largely prevented from coming off.

In a further advantageous embodiment, it is provided for the spindle nut and the tube to be connected to one another in the overlap region via an elongate welding seam. The welding seam preferably extends at least partially around an outer circumference of the spindle nut. In an advantageous embodiment, the welding seam is designed to be annular and extends around the entire outer circumference of the spindle nut. Alternatively, the welding seam runs parallel to the longitudinal axis of the tube. In an expedient development, more than one welding seam is provided via which the spindle nut and the tube are connected to one another in the overlap region.

In an expedient embodiment of the spindle assembly, it is provided for the tube to have a connecting section at a second end opposite the first end. Particularly preferably, the connecting section is designed as an external thread. It is thus advantageously possible to fasten the tube, for example, to a housing part of a spindle device or a connection element such as a ball socket via a screw connection. Alternatively, however, it can also be provided that the second end of the tube opposite the first end can be fastened to a connection element such as a ball socket or the like by other fastening methods, such as welding, in particular laser welding, gluing or pressing. Accordingly, corresponding geometric configurations of the connecting section, such as grooves or the like, can be provided at the second end of the tube.

Further advantages, properties, and developments of the present disclosure emerge from the following description of a preferred exemplary embodiment.

### BRIEF SUMMARY OF THE DRAWINGS

The present disclosure is explained in more detail below with reference to the accompanying drawings using a preferred exemplary embodiment.

FIG. 1 shows a preferred exemplary embodiment of a spindle assembly according to the present disclosure in a cross-sectional view.

FIG. 2 shows an enlarged view in the region of the first end 4a of the tube 4 of FIG. 1.

FIG. 3 shows an enlarged view in the region of the first end 4a of the tube 4 after welding has taken place.

### DETAILED DESCRIPTION

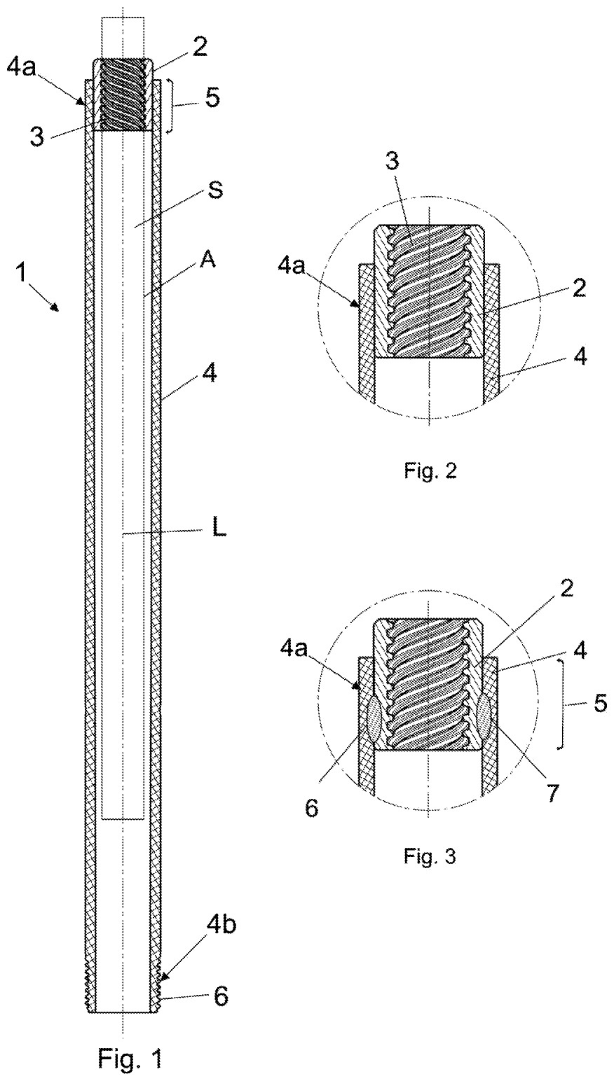

FIG. 1 shows a preferred exemplary embodiment of a spindle assembly 1 according to the present disclosure in a cross-sectional view. The spindle assembly 1 comprises a hollow cylindrical spindle nut 2 with an internal thread 3, which is designed to be in threaded engagement with a spindle rod S indicated here, which has an external thread A that matches the internal thread 3. In the exemplary embodiment shown here, the spindle nut 2 is made of a laser-nontransparent plastic. Advantageously, the spindle nut 2 can thus be produced inexpensively in large quantities, for example in an injection molding process, the spindle nut 2 thus produced being designed to be robust and weight-saving at the same time.

Furthermore, the spindle assembly 1 comprises a tube 4 designed as a guide tube, which can be connected, for example, to a housing part of a spindle device. In this case, the tube 4 essentially serves the purpose that both the spindle nut 2 and the spindle rod S which can be brought into threaded engagement with the spindle nut 2 can be guided in the radial direction relative to one another and also relative to a housing of the spindle device. The intention is, in particular, to prevent the spindle rod S from becoming displaced relative to the spindle nut due to its own weight and, possibly, to prevent cross-threading of the internal thread 3 of the spindle nut 2 relative to the external thread A of the spindle rod S due to radial forces that may then occur. Further, the corresponding guidance is to generally increase the long-life cycle of the spindle assembly 1, i.e., to reduce wear and to ensure the smoothest possible functionality.

The tube 4 is made of plastic, wherein the plastic is designed to be laser-transparent. This advantageously creates the possibility of inserting the spindle nut 2 in the tube 4 concentrically to the longitudinal axis L of the tube 4 and producing a welded connection between the spindle nut 2 and the tube 4 in an axial overlap region 5 between the spindle nut 2 and the tube 4 by irradiation of a laser. The laser is radiated through the tube 4 transversely to the longitudinal axis L, wherein the tube 4 is not damaged or melted externally by the laser due to the fact that the tube 4 is made of a laser-transparent plastic. In the axial overlap region 5, the laser then impinges on the outer side of the spindle nut 2 which is made of a laser-nontransparent plastic. The spindle nut 2 is correspondingly heated on its outer side by the laser and melts accordingly locally, wherein this simultaneously leads to the fact that the inner side of the tube 4 also melts due to the local heating, thus producing a cohesive connection by welding between the spindle nut 2 and the tube 4.

FIG. 1 shows the spindle assembly 1 in a state in which the spindle nut 2 is inserted into a first open end 4a of the tube 4 and is held only by friction. The spindle nut 2 accordingly has an outer diameter which is somewhat larger than the inner diameter of the tube 4. At a second end 4b opposite the first end 4a, the tube 4 has on its outer side a connecting section which is designed as an external thread 6 and is provided, for example, for connecting the tube 4 to a housing part of a spindle device.

FIG. 2 shows an enlarged view in the region of the first end 4a of the tube 4. In this view it can be seen that the spindle nut 2 protrudes from the first open end 4a of the tube 4. Accordingly, the overall length of the spindle assembly 1 is defined by the sum of the length of the tube 4 and the length of the part of the spindle nut 2 which protrudes from the first open end 4a of the tube 4.

Advantageously, the overall length of the spindle assembly 1 can thus be adapted by changing the axial position of the spindle nut 2 relative to the tube 4. It is thus advantageously possible to define a flexible overall length of the spindle assembly 1 in high precision without subsequent trimming of the tube 4. In the event that the overall length of the spindle assembly 1 is to correspond to the length of the tube 4, the spindle nut is displaced deeply into the tube 4 before welding with the tube 4 until the spindle nut 2 no longer protrudes from the tube 4, and is subsequently welded to the tube 4. Moreover, depending on the design of the spindle rod S to be brought into threaded engagement with the spindle nut 2, the spindle nut 2 can also be axially secured in a region between the first end 4a and the second end 4b of the tube.

Due to the axial securing of the spindle nut 2 by means of laser welding after fixing the position, no other mechanical action is necessary, which could lead to an axial displacement of the spindle nut 2 relative to the tube 4 during fastening. Moreover, the axial securing can be carried out in a very time-saving manner in particular in comparison to an adhesive bonding of the spindle nut 2 to the tube 4.

FIG. 3 shows an enlarged view in the region of the first end 4a of the tube 4 after welding has taken place. A first welding spot 6 and a second welding point 7, which is radially opposite the first welding point 6, was produced within the axial overlap region 5 by laser welding, which were produced by melting the contact region between the spindle nut 2 and the tube 4. Accordingly, the spindle nut 2 is advantageously integrally bonded to the tube 4 by welding and is correspondingly secured axially relative to the tube 4. As an alternative to welding at certain points, it is also possible to provide an annular welding seam. Accordingly, the laser beam is guided radially around the overlap region 5 to produce the annular welding seam between the spindle nut 2 and the tube 4.

The present disclosure has been explained above with reference to an exemplary embodiment in which two welding points are provided for axially securing the spindle nut 2. It should be understood that four welding points can also be provided, in each case two welding points being radially opposite each other.

The present disclosure has been explained above with reference to an exemplary embodiment in which the tube 4 is designed as a hollow cylinder with a circular cross section. It should be understood that the tube can also have an elliptical or rectangular cross section, wherein at least the outer side of the spindle nut has a corresponding negative shape, so that the spindle nut can be inserted into the first open end of the tube and, if necessary, can be frictionally connected to prepare for the subsequent welding.

The present disclosure has been explained above with reference to an exemplary embodiment in which the first welding point 6 and, respectively, the second welding point 7 is provided in a central region of the overlap region 5. It should be understood that the position of the welding points both in the direction of the longitudinal axis L and the angular position of the welding points can be freely selected in principle.

1-22. (canceled)

23. A spindle assembly for a spindle device, comprising:
a spindle nut configured for being brought into threaded engagement with a spindle rod; and
a tube extending axially along a longitudinal axis;
wherein the tube at least in a section encircles the spindle nut radially and the spindle nut and the tube overlap in an axial overlap region,
wherein the spindle nut is axially secured to the tube by welding,
wherein the spindle nut and the tube are welded to one another in an inner region of the axial overlap region.

24. The spindle assembly according to claim 23, wherein the spindle nut is axially secured to the tube by laser welding.

25. The spindle assembly according to claim 23, wherein the spindle nut is made of a plastic.

26. The spindle assembly according to claim 23, wherein the spindle nut is made of a laser-nontransparent plastic at least at an outer circumference.

27. The spindle assembly according to claim 23, wherein the tube is made at least in sections of a plastic.

28. The spindle assembly according to claim 23, wherein the tube is made entirely of plastic.

29. The spindle assembly according to claim 28, wherein the tube is made of a laser-transparent plastic.

30. The spindle assembly according to claim 23, wherein the spindle nut is arranged at a first open end of the tube.

31. The spindle assembly according to claim 30, wherein the spindle nut protrudes from the first open end of the tube.

32. The spindle assembly according to claim 23, wherein the spindle nut is arranged concentrically about the longitudinal axis of the tube.

33. The spindle assembly according to claim 32, wherein the spindle nut and the tube touch in the axial overlap region.

34. The spindle assembly according to claim 33, wherein a frictional connection exists between the spindle nut and the tube in the overlap region.

35. The spindle assembly according to claim 33, wherein the spindle nut and the tube are connected to one another in the overlap region via at least one first welding point.

36. The spindle assembly according to claim 35, wherein the spindle nut and the tube are connected to one another in the overlap region via a second welding point spaced apart from the first welding point.

37. The spindle assembly according to claim 36, wherein the first welding point is provided in a central axial portion of the overlap region.

38. The spindle assembly according to claim 23, wherein the spindle nut and the tube are connected to one another in the overlap region via an elongate welding seam.

39. The spindle assembly according to claim 38, wherein the welding seam extends at least partly around an outer circumference of the spindle nut.

40. The spindle assembly according to claim 38, wherein the welding seam is designed to be annular and extends around an entire outer circumference of the spindle nut.

41. The spindle assembly according to claim 38, wherein the welding seam extends parallel to the longitudinal axis of the tube.

42. The spindle assembly according to claim 38, wherein more than one welding seam is provided, via which the spindle nut and the tube are connected to one another in the overlap region.
